(19) United States
(12) Patent Application Publication
(10) Pub. No.: US 2020/0335229 A1
(43) Pub. Date: Oct. 22, 2020

(54) THERMO-KINETIC REACTOR WITH MICRO-NUCLEAR IMPLOSIONS

(71) Applicant: Constantin Tomoiu, Ansonia, CT (US)

(72) Inventor: Constantin Tomoiu, Ansonia, CT (US)

(21) Appl. No.: 16/921,186

(22) Filed: Jul. 6, 2020

Related U.S. Application Data
(63) Continuation-in-part of application No. 15/672,944, filed on Aug. 9, 2017.
(60) Provisional application No. 62/419,917, filed on Nov. 9, 2016.

(51) Int. Cl. G21B 1/05; G10K 15/04; F23L 7/00; F23C 99/00; F02M 27/08

(52) U.S. Cl. CPC G21B 1/05; G10K 15/043; F02M 27/08; F23C 99/003; F23L 7/005

(57) ABSTRACT

A thermo-kinetic reactor and process where a micro-packet of a mixture of air, fuel, and water are exposed to high energy ultrasound, a high frequency electromagnetic field, and thermal energy self-generated to initiate micro-nuclear fusion. A reaction chamber with a nozzle and adjacent resonance chamber form micro-packets and micro-explosions. The micro-explosions form high negative pressure bubbles which implode accelerating fusible elements towards a center forming a nucleus generating kinetic energy.

### RELATED APPLICATION

This application is a continuation-in-part of U.S. patent application Ser. No. 15/672,944 filed Aug. 9, 2017 which claims the benefit of U.S. Provisional Application No. 62/419,917 filed Nov. 9, 2016, all of which are incorporated herein by reference.

### FIELD OF THE INVENTION

The present invention relates in general to an efficient heat generator, and more particularly to a process and device implementing a momentary micro-nuclear fusion reactor or MMNFR.

### BACKGROUND OF THE INVENTION

There have been numerous efforts in the past to develop efficient energy sources. These efforts include U.S. Pat. No. 6,804,963 entitled “Thermo-reactor with Linear to Rotational Motion Conversion”, issuing Oct. 19, 2004 to Tomoiu; U.S. Pat. No. 8,752,665 entitled “Thermo-Acoustic Reactor with Molecular Disassociation” issuing Jun. 17, 2014 to Tomoiu; and U.S. Pat. No. 9,454,955 entitled “Thermo-Acoustic Reactor with Non-Thermal Energy Absorption in Inert Medium” issued on Sep. 27, 2016 to Constantin Tomoiu, all of which are incorporated herein by reference.

For the past sixty years research has been conducted into controlled fusion, with the goal of producing clean energy. Extreme scientific and technical difficulty has been encountered. Currently, controlled fusion reactions have been unable to produce a self-sustaining controlled fusion reaction.

Nuclear fusion is the release of energy with the fusion of light elements to create a heavier nucleus, a free neutron, or a proton. The process is exothermic where more energy is released via E=mc² through the difference in nucleons binding energy.

The two most advanced approaches for artificial nuclear fusion are: Magnetic Confinement (Tokamak) and Inertial Confinement Fusion (laser confinement).

Around 1920 Arthur Eddington stated hydrogen-helium fusion could be the primary source of stellar energy. In 1932 fusion of hydrogen isotopes was accomplished by Mark Oliphant.

The First Tokamak T-1 began operation at Kurchatov Institute in Moscow at the end of 1958.

Over 60 years research has been conducted into controlled fusion. Currently, it has not been possible to achieve breakeven: energy input=energy output or Q=1. Over 100 fusion reactors have been built worldwide. None of these have had successful breakeven.

In 1997 JET (Joint European Tours) achieved a fusion efficiency of 0.67% (Q=0.67), a world record for Deuterium-Tritium fusion reaction. This was still less output power than input power. The total input at the peak was greater than 1,000 MW with a brief output of 16 MW, resulting in overall efficiency of only 1.6%. The JET project is a nearly 40 years effort (beginning testing in 1983) leveraging 40 laboratories and 350 scientists.

The world record for plasma confinement time was achieved on Jul. 3, 2017 by EAST (Experimental Advanced Superconducting Tokomak) reactor in Hefei China which successfully sustained high confinement (H-mode) plasma for 102 seconds.

The National Ignition Facility (NIF) at the “Lawrence National Laboratory” using its lasers system of 192 beams delivered more than 500 MW and 1.85 MJ of ultraviolet laser to a 2 mm diameter target for a few trillions of a second. NIF on 2014 proudly reported a 17 KJ (4.7 W) that exceeded the amount of energy absorbed by the 2 mm target, but not the amount supplied by the giant lasers. DOE (Department of Energy) admitted that NIF's $3.5 billion experiment was a failure.

MIT's groundbreaking “Mini Fusion Reactor” (MFR) was operated from 1991 to 2016 and then shut down. The reactor failed to power the world in 10 years as MIT had stated in the beginning.

The U.S. Department of Energy's Princeton Plasma Physics Laboratory (PPPL) runs the National Spherical Torus Experiment (NSTX), which has undergone a $94 million upgrade that was completed in 2015, a 4-year effort. The NSTX fusion reactor was shut down for malfunctions caused by catastrophic damages of brief plasma operation.

Lockheed Martin's Compact Nuclear Fusion Reactor (CNFR), small enough to fit on the back of a truck and was thought to be capable of being commercialized in 5 years. However, at 20 tons weight it is 100 times larger after 5 years and Lockheed Martin is struggling to get even close to their claims.

The International Thermonuclear Experimental Reactor (ITER), the most promising nuclear fusion reactor in the Cadarache facility southern France by a 35 country effort is expected to operate in 2035 for 1,000 seconds and produce 500 MW of thermal energy with an input of 50 MW of thermal power injected in the reactor. The total electricity consumed by the reactor and facility during peak period of plasma operation will be as much as 620 MW. Converting 500 MW of thermal energy output to electric energy (as input), the ITER may end up with around 32% efficiency. ITER will produce no electricity.

There is a need for continued improvement to obtain practicality and greater efficiencies in generating energy.

### SUMMARY OF THE INVENTION

The present invention uses a thermo-kinetic process where a micro-packet of a mixture of air, fuel, and water are exposed to self-generated high energy ultrasound, a high frequency electromagnetic field, and thermal energy to initiate micro-nuclear fusion. Microscopic packets or micro-packets of air-fuel and water are formed with water/fuel ratio by mass of up to 87.09/1. The micro-packets may contain light fusible elements, such as deuterium and tritium. There may also be an electrically conductive fluid introduced into the micro-packets, such as salt water. Air-fuel in the micro-packets is initially ignited by an induction coil to generate micro-explosions in a reaction chamber. The micro-explosions propel with high velocity the contained particles including water molecules which elastically collide with other water molecules in a reaction zone and with hot reactor components. As the micro-explosions continue to expand, contained particles including water molecules are moving outward from the center of the micro-explosion where a void or a high negative pressure bubble is formed. When the pressure of the expanding micro-explosion equals the pressure of gases in the reaction chamber, then particles stop moving outward and the bubble violently implode. Water molecules filling the bubble void are accelerated towards the center of the collapsing bubble where the water molecules elastic collide with high velocities triggering a nuclear reaction where hydrogen fuses to form a heavier nucleus where mass is converted into kinetic energy via E=mc². The excess kinetic energy is stored in the degrees of freedom of a light water causing its temperature to rise. The combination of a micro-explosion with the generation of a high negative pressure bubble and implosion of the bubble creates a momentary micro-nuclear fusion reactor or MMNFR.

The collapsing bubble generates high temperature plasma and a shock wave. A confining magnetic field is generated by the plasma currents. Plasma is electrically conductive and interacts with eddy currents generated by an induction coil where the temperature is farther increased.

Accordingly, it is an object of the present invention to provide an efficient energy source.

It is an advantage of the present invention that it does not rely solely on a chemical reaction to produce energy.

It is a feature of the present invention that the MMNFR is used to generate energy where mass is converted to energy.

These and other objects, advantages, and features will become more readily apparent in view of the following detailed description.

### BRIEF DESCRIPTION OF THE DRAWINGS

FIG. 1 schematically illustrates an embodiment of the present invention.

FIG. 2 schematically illustrates another embodiment having an induction coil where an electrically conductive resonance chamber and nozzle are directly heated by eddy currents generated by electric current in the induction coil.

### DETAILED DESCRIPTION OF THE INVENTION

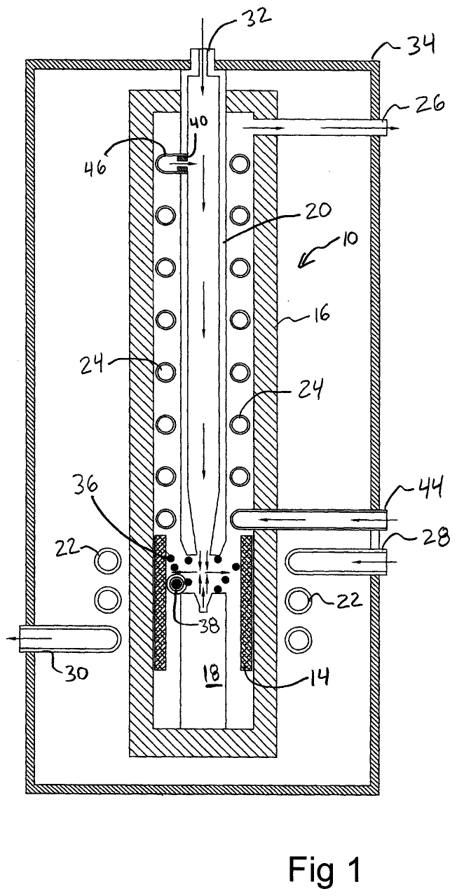

FIG. 1 schematically illustrates the thermo-kinetic reactor 10 with reaction chamber 16. Placed within reaction chamber 16 are nozzle 20 and resonance chamber 18. Resonance chamber 18 has a conic-cylindrical geometry. Iron cylinder 14 is placed within a portion of the reaction chamber 16 and is heated by a high frequency alternating magnetic field generated by induction coil 22. Induction coil 22 has an input port 28 and output port 30 for water cooling. Coil 24 is placed in reaction chamber 16. Coil 24 has an input port 44 and output port 46. Outlet port 46 communicates with nozzle 20 through restriction passage 40. High pressure water steam formed in coil 24 will mix with air and fuel in nozzle 20. Nozzle 20 has an air-fuel input port 32. Reaction chamber 16 has an exhaust port 26. The thermo-kinetic reactor 10 is enclosed in a thermal insulation chamber 34.

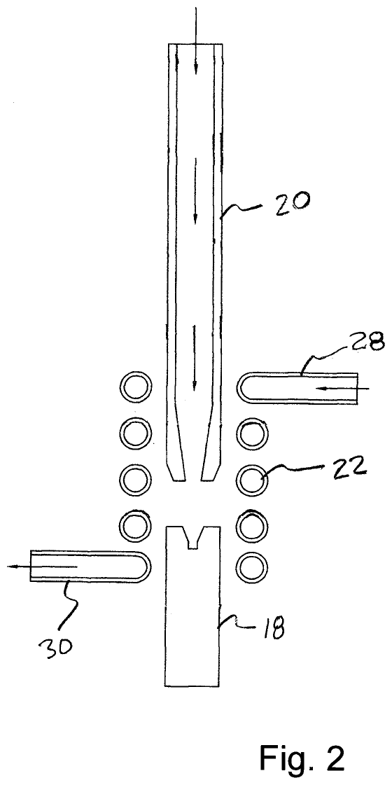

FIG. 2 schematically illustrates an embodiment of the micro-packets and ultrasound generator of the present invention with a resonance chamber 18 and nozzle 20 made of an electrically conductive material. Induction coil 22 is wrapped around resonance chamber 18 and nozzle 20. Resonance chamber 18 and nozzle 20 are heated by eddy currents generated therein by the flowing electrical current in induction coil 22. In this embodiment there is no need for the iron cylinder 14 illustrated in FIG. 1.

The operation of thermo-kinetic reactor 10 can readily be appreciated by the following description. Induction coil 22 is energized to bring iron cylinder 14 to a high temperature. Cooling water is circulated through induction coil 22. Air and fuel are input at the air and fuel inlet port 32 and directed into nozzle 20. Water is circulated in coil 24 from input port 44 to form high pressure steam. At output port 46 a restriction passage 40 causes high pressure steam to exit from coil 24 to mix with the air and fuel mixture in nozzle 20. The air, fuel, and steam mixture in nozzle 20 flows with supersonic velocity into resonance chamber 18. When the pressure in resonance chamber 18 becomes greater than the incoming pressure from nozzle 20 the air, fuel, and steam mixture flows in an opposite direction colliding with incoming air, fuel, and steam mixture traveling towards the resonance chamber 18 in nozzle 20. At this very moment flow from nozzle 20 is interrupted and micro-packet 36 of an air, fuel, and steam mixture forms, and a pressure wave is generated. The air-fuel from micro-packets 36 are ignited by the hot iron cylinder 14 forming micro-explosions 38. The micro-explosions 38 generate electromagnetic, acoustic, and thermal energy. This results in a high negative pressure void or bubble being formed as the micro-explosions 38 expand.

The micro-explosions 38 propel particles with high velocity causing the particles to collide with other particles in the reaction zone and with the hot components of the hot iron cylinder 14 and the walls of the reactor 16. As the micro-explosions 38 continue to expand and push on the surrounding high pressure gases, the internal pressure of the expanding micro-explosion 38 continue to decrease due to the high velocity particles moving outward from the center of the micro-explosions 38. This forms a void or high negative pressure bubble. When the pressure of expanding micro-explosions 38 equals the pressure of gases in the reaction chamber 16, then the bubble violently implodes and collapses to generate high temperature plasma and a shock wave. A confining magnetic field is self-generated by the plasma currents. When the bubble collapses water molecules at the inner boundary surface of the bubble are accelerated towards the center of the collapsing bubble to fill the void where the particles collide to form plasma. At this moment matter contained in the plasma interact with eddy currents when the induction coil is energized.

At the end stage of the collapsing bubble, hydrogen fuses to form a heavier nucleus resulting in the release of kinetic energy. The excess kinetic energy is stored in the degrees of freedom of light water causing its temperature to rise. At thermal equilibrium the light water temperature is increased almost entirely by the thermo-kinetic-nuclear process. The mixture of water, steam, and combustion products exit the reactor chamber 16 through port 26 at a temperature near 1,0000 C°

The Tomoiu thermo-kinetic process of the present invention was demonstrated with five prototype reactors that have been independently tested and operated with a mixture of: air, water, and fuel simultaneously introduced at a reactor inlet port. Reported test data shows that the water-fuel ratio by mass was up to 87.09/1 and there was a continuous output of energy of 15.692 MJ/hr. from an input of 4.407 MJ/hr. The efficiency of the Gamma-2 reactor has excided 356%.

Additional test have been conducted establishing the utility and practicality of the present invention.

On May 1, 2019 at CITY COLLEGE of NEW YORK (CCNY) in the Combustion and Catalysis Laboratory (CCL) under supervision of Professor Marco J. Castaldi and his team, the (TTKR) TOMOIU THERMO-KINETIK REACTOR (Alpha reactor) demonstrated an output of 14.948 MJ/hr. with a 5.033 MJ/hr. input of chemical energy. This was done by reacting 35.4 grams of hydrogen per hour with air and water. The efficiency of the TTKR is 297% (or Q=2.97) and has been sustained repeatedly. Excess energy is 9.915 MJ/hr. Mass is converted to energy via E=mc²: 1.10319 e⁻¹⁰ Kg/hr.

Additional testing was performed on Sep. 20, 2019 at THE CITY COLLEGE of NEW YORK (CCNY) in the Combustion and Catalysis Laboratory (CCL) under supervision of Professor Marco J. Castaldi and his team, the (TTKR) TOMOIU THERMO-KINETIK REACTOR (Gamma-2 reactor) demonstrated an output of 21.395 MJ/hr. with a 4.407 MJ/hr. input of chemical energy. This was done by reacting 31 grams of hydrogen per hour with air and water. The efficiency of this TTKR (Gamma-2 reactor) is 485.477% (or Q=4.85) and has been sustained repeatedly. Excess energy is 16.988 MJ/hr. Mass converted to energy via E=mc²: 1.890 e⁻¹⁰ Kg/hr.

The following Table I is a summary of the test results of various reactors embodying and operating in accordance with the present invention.

TABLE I

| | | AIR | FUEL | WATER | Reactor | Exhaust | Fuel Heat | Output Heat | Excess Heat | |
|---|---|---|---|---|---|---|---|---|---|---|
| REACTOR | Tested by: | Kg/hr. | Kg/hr. | Kg/hr. | Temp. ° C. | Temp. ° C. | MJ/hr. | MJ/hr. | MJ/hr. | PI |
| Alpha | Professor | 3.847 | H₂ | 1.610 | 989 | 894 | 5.033 | 14.948 at | 9.915 | 2.97 |
| May 1, 2019 | Marco Castaldi | | 0.035 | | | | | exhaust temp. | | |
| | PhD CCNY | | | | | | | | | |
| Gamma-2 | Professor | 3.100 | Ethanol | 1.620 | Unknown | 1,041 | 8.301 | 16.635 at | 8.334 | 2.0 |
| Aug. 6, 2019 | Marco Castaldi | | 0.308 | | | | | exhaust temp. | | |
| | PhD CCNY | | | | | | | | | |
| Gamma-2 | Professor | 3.174 | H₂ | 2.700 | 1,139 | 719 | 4.407 | 15.692 at | 11.285 | 3.56 |
| Sep. 20, 2019 | Marco Castaldi | | 0.031 | | | | | exhaust temp. | | |
| | PhD CCNY | | | | | | | | | |
| Gamma-2 | Professor | 1.255 | CO | 1.980 | Unknown | 840 | 4.595 | 12.713 at | 8.118 | 2.766 |
| Nov. 22, 2019 | Marco Castaldi | | 0.455 | | | | | exhaust temp. | | |
| | PhD CCNY | | | | | | | | | |
| Gamma-2 | N. Ostroff PhD | 4.826 | H₂ | 2.903 | 1,021 | 755 | 5.893 | 17.145 at | 11.252 | 2.909 |
| Aug. 30, 2019 | H. Agahegien PhD | | 0.041 | | | | | exhaust temp. | | |
| Beta | N. Ostroff PhD | 3.175 | Ethanol | 1.730 | Unknown | 1,069 | 8.127 | 12.567 at | 4.440 | 1.55 |
| Jun. 6, 2018 | | | 0.303 | | | | | exhaust temp. | | |
| Gamm-2 | N. Ostroff PhD | 3.483 | Ethanol | 1.680 | Unknown | 1,133 | 8.301 | 15.175 at | 6.874 | 1.828 |
| Jun. 13, 2018 | | | 0.308 | | | | | exhaust temp. | | |
| Delta | N. Ostroff PhD | 3.375 | C₃H₈ | 4.631 | 1,159 | 105 | 6.204 | 16.233 at | 10.029 | 2.61 |
| Jun. 28, 2016 | | | 0.134 | | | | | exhaust temp. | | |
| Gamm-1 | E. Mirica PhD | 1.905 | C₃H₈ | 1.500 | Unknown | 984 | 3.612 | 9.740 at | 6.128 | 2.696 |
| Apr. 27, 2016 | | | 0.072 | | | | | exhaust temp. | | |
| Alpha | E. Mirica PhD | 1.806 | C₃H₈ | 1.116 | 1,093 | 846 | 6.103 | 7.350 at | 1.274 | 1.204 |
| Jan. 7, 2016 | | | 0.122 | | | | | exhaust temp. | | |

During each test of the invention identified in the above Table I it is noted that, (1) the mass & energy balance has been calculated at temperature of combustion products and water steam exiting the reactor; (2) the ignition system after starting the reactor was shut off; (3) no other external energy was supplied to the reactor in addition to chemical energy contained in the amount of fuel/hr. used in the experiment; and (4) the Performance index is PI was calculated by total heat divided by fuel heat or

$$\frac{total heat}{fuel heat} .$$

Following is a summary report dated May 8, 2020 and extracts of test data of tests conducted of multiple reactors embodying the present invention that demonstrates enablement and utility of the invention. The report was prepared by Marco J. Castaldi, Ph.D. of The City College of New York.

As can be seen from the above test results of reactors embodying the present invention, the data shows that the reactors output net energy. Therefore, the reactors embodying the present invention are enabled and clearly have utility. The present invention provides an apparatus and process for producing or converting forms of energy or matter so as to provide a source of thermal energy that may be used in many utilitarian or practical applications.

While the present invention has been described with respect to several different embodiments, it will be obvious that various modifications may be made without departing from the spirit and scope of this invention.

What is claimed is:

1. A thermo-kinetic reactor with micro-nuclear implosions comprising:
a micro-packet and ultrasound generator having a nozzle and a resonance chamber with a conic-cylindrical geometry placed in a reaction chamber;
a passage formed between the nozzle and the resonance chamber of said micro-packet and ultrasound generator;
a coil placed in the reaction chamber having an input port for noncombustible fluid or water and an output port coupled to the nozzle;
the reaction chamber having an exhaust port and an iron cylinder placed inside the reaction chamber;
an induction coil wrapped around the reaction chamber having an induction coil input and an induction coil output port for water cooling; and
a thermal insulation chamber, whereby heat loss is minimized,
whereby the nozzle introduces a mixture of fuel and air and water steam from the coil,
whereby the mixture of fuel and air and water steam flow into the conic-cylindrical geometry of the resonance chamber to form a micro-packet and generate a pressure wave,
whereby the micro-packet ignites to form a micro-explosion in the reaction chamber and generating high frequency acoustic wave.

2. The thermo-kinetic reactor with micro-nuclear implosions as in claim 1 wherein:
said induction coil wrapped around the nozzle and resonance chamber is for direct heating; and
the nozzle and resonance chamber are made of materials with magnetic properties.

3. A thermo-kinetic reactor with micro-nuclear implosions which creates momentary micro-nuclear fusion reactors or MMNFR comprising the steps of:
forming a micro-packet of air, fuel, and water;
exploding the micro-packet of air, fuel and water mixture to form a micro-explosion;
forming a high negative pressure void or bubble in a center of micro-explosion;
where water molecules elastic collides at the center of collapsing bubble.
wherein a high negative pressure bubble implosive collapses to form plasma and a self-confining magnetic field;
wherein high negative pressure bubble implosive collapses to generate a shock wave;
wherein Hydrogen fuse to form a heavier element with the release of kinetic energy;
wherein kinetic energy is stored in the degrees of freedom of moderator light water causing its temperature to rise.

4. A method to generate heat in a reaction zone using an iron cylinder electromagnetically coupled with an induction coil where air fuel mixture from a micro-packet auto ignite to generate electromagnetic, acoustic and thermal energy.

5. A method for generating a micro-explosion using an electrically conductive liquid mixed with air, and a fuel, comprising the steps of:
introducing an electrically conductive fluid or mixture of fluids in micro-packets and using a micro-packet generator to form micro-packets;
exposing the micro-packets to high frequency electromagnetic energy where eddy currents are formed in the electrically conductive fluid in the micro-packets causing its temperature to rise;
further exposing the micro-packets with the electrically conductive fluid to thermal, acoustic and electromagnetic energy where a micro-explosion is generated;
forming a void or bubble in the center of the micro-explosion; and
collapsing the bubble where fusible elements fuse to form a heavier element with the release of kinetic energy.

6. The method as in claim 5 comprising the further step of:
enriching the input of air, fuel, and light water with fusible elements comprising deuterium and tritium so as to increase efficiency.

7. A method of generating energy with a thermo-kinetic reactor comprising the steps of:
injecting a mixture of air, fuel, and steam at a nozzle pressure through a nozzle having an outlet placed adjacent a resonance chamber in a reaction chamber;
increasing a resonance chamber pressure in the resonance chamber greater than the nozzle pressure;
forming micro-packets of the mixture and generating a pressure wave;
igniting the micro-packets forming micro-explosions, whereby electromagnetic, acoustic, and thermal energy is generated;
creating a negative pressure bubble as the micro-explosions expand;
imploding and collapsing the negative pressure bubble, whereby particles comprising fusible elements in the negative pressure bubble accelerate towards a center of the negative pressure bubble generating a plasma and shock wave;
generating eddy currents in the plasma, whereby temperature and pressure are increased and the fusible elements are compressed; and
fusing the fusible elements forming a nucleus, whereby kinetic energy is released,
whereby energy is generated by said step of fusing of the fusible elements.
